(19) United States
(12) Patent Application Publication
(10) Pub. No.: US 2017/0019820 A1
(43) Pub. Date: Jan. 19, 2017

(54) ENHANCEMENTS FOR DISCONTINUOUS RECEPTION IN WIRELESS COMMUNICATIONS

(71) Applicant: QUALCOMM Incorporated, San Diego, CA (US)

(72) Inventor: Soumya Das, San Diego, CA (US)

(21) Appl. No.: 14/802,862

(22) Filed: Jul. 17, 2015

(51) Int. Cl. H04W 36/00; H04W 72/04; H04W 48/20; H04W 76/04

(52) U.S. Cl. CPC H04W 36/0016; H04W 76/048; H04W 72/0406; H04W 48/20; H04W 88/02

(57) ABSTRACT

A method, an apparatus, and a computer program product for wireless communication are provided in which a user equipment (UE) transmits a DRX modification request to a first base station, wherein the DRX modification request provides DRX assistance data for assisting the first base station in determining a second DRX configuration of the UE. The UE further receives one or more DRX parameters corresponding to the second DRX configuration from the first base station, and the UE is configured to utilize the second DRX configuration based on the one or more DRX parameters.

### TECHNICAL FIELD

The technology discussed below relates generally to wireless communication systems, and more particularly, to discontinuous reception (DRX) in wireless communications.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency divisional multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example of a fourth generation (4G) telecommunication standard is Long Term Evolution (LTE). LTE is a set of enhancements to the Universal Mobile Telecommunications System (UMTS) mobile standard promulgated by Third Generation Partnership Project (3GPP). It is designed to better support mobile broadband Internet access by improving spectral efficiency, lower costs, improve services, make use of new spectrum, and better integrate with other open standards using OFDMA on the downlink (DL), SC-FDMA on the uplink (UL), and multiple-input multiple-output (MIMO) antenna technology. However, as the demand for mobile broadband access continues to increase, there exists a need for further improvements in LTE technology and other telecommunication standards.

### BRIEF SUMMARY OF SOME EXAMPLES

The following presents a simplified summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

Aspects of the present disclosure provide a number of enhancements to UE discontinuous reception (DRX) operations that can reduce DRX latency and/or failed handover occurrences. In one aspect, the disclosure provides a method of operating a user equipment (UE) to perform discontinuous reception (DRX) for wireless communication. The UE communicates with a first base station utilizing a first DRX configuration. The UE transmits a DRX modification request to the first base station, wherein the DRX modification request includes DRX assistance data for assisting the first base station in determining a second DRX configuration of the UE. The UE receives one or more DRX parameters corresponding to the second DRX configuration from the first base station. The UE is configured to utilize the second DRX configuration based on the one or more DRX parameters.

Another aspect of the disclosure provides a method of operating a base station. The base station communicates with a user equipment (UE) utilizing a first DRX configuration among a plurality of predetermined DRX configurations. The base station hands over the UE to a second base station in a handover operation including transmitting UE context information to the second base station. The UE context information includes the plurality of predetermined DRX configurations.

Another aspect of the disclosure provides a user equipment (UE) for wireless communication. The UE includes a memory including executable code, a communication interface, and at least one processor operatively coupled to the memory and the communication interface. The at least one processor when configured by the executable codes, is configured to communicate with a first base station via the communication interface utilizing a first DRX configuration. The at least one processor is configured to transmit a DRX modification request to the first base station, wherein the DRX modification request includes DRX assistance data for assisting the first base station in determining a second DRX configuration of the UE. The at least one processor is further configured to receive one or more DRX parameters corresponding to the second DRX configuration from the first base station. The at least one processor is further configured to utilize the second DRX configuration based on the one or more DRX parameters.

Another aspect of the disclosure provides a base station for wireless communication. The base station includes a memory including executable code, a communication interface, and at least one processor operatively coupled to the memory and the communication interface. The at least one processor when configured by the executable code, is configured to communicate with a user equipment (UE) utilizing a first DRX configuration among a plurality of predetermined DRX configurations and hand over the UE to a second base station in a handover operation including transmitting UE context information to the second base station. The UE context information includes the plurality of predetermined DRX configurations.

These and other aspects of the invention will become more fully understood upon a review of the detailed description, which follows. Other aspects, features, and embodiments of the present invention will become apparent to those of ordinary skill in the art, upon reviewing the following description of specific, exemplary embodiments of the present invention in conjunction with the accompanying figures. While features of the present invention may be discussed relative to certain embodiments and figures below, all embodiments of the present invention can include one or more of the advantageous features discussed herein. In other words, while one or more embodiments may be discussed as having certain advantageous features, one or more of such features may also be used in accordance with the various embodiments of the invention discussed herein. In similar fashion, while exemplary embodiments may be discussed below as device, system, or method embodiments it should be understood that such exemplary embodiments can be implemented in various devices, systems, and methods.

### BRIEF DESCRIPTION OF THE DRAWINGS

FIG. 1 is a diagram illustrating an LTE network architecture employing various apparatuses in accordance with some aspects of the disclosure.

FIG. 2 is a diagram illustrating an example of an access network in an LTE network architecture in accordance with some aspects of the disclosure.

FIG. 3 is a diagram illustrating an example of the radio protocol architecture for the user and control planes in accordance with some aspects of the disclosure.

FIG. 4 is a diagram illustrating an example of LTE mobility management in accordance with an aspect of the disclosure.

FIG. 5 is a diagram illustrating an example of a Connected Mode DRX (CDRX) timeline in accordance with an aspect of the disclosure.

FIG. 6 is a diagram illustrating an example of a hardware implementation for an apparatus employing a processing system in accordance with an aspect of the disclosure.

FIG. 7 is a block diagram of an eNB in communication with a UE in an access network in accordance with an aspect of the disclosure.

FIG. 8 is a diagram illustrating the communication between a UE and an eNB utilizing power preference indication (PPI) messages and DRX assistance information to configure DRX operations in accordance with some aspects of the disclosure.

FIG. 9 is a diagram illustrating an RRC information element that may be utilized by a UE to transmit UE assistance information to an eNB for configuring DRX operations in accordance with some aspects of the disclosure.

FIG. 10 is a flow chart illustrating a DRX control method operable at a UE in anticipation of a handover in accordance with some aspects of the disclosure.

FIG. 11 is a diagram illustrating an example implementation of the DRX control method of FIG. 10 in accordance with some aspects of the disclosure.

FIG. 12 is a diagram illustrating a handover method operable at a UE utilizing UE context information for configuring DRX operations in accordance with some aspects of the disclosure.

FIG. 13 is a diagram illustrating an example implementation of the handover method of FIG. 12 in accordance with some aspects of the disclosure.

FIG. 14 is a diagram illustrating a handover method operable at a base station utilizing UE context information for configuring DRX operations in accordance with some aspects of the disclosure.

FIG. 15 is a diagram illustrating a handover method operable at a UE utilizing UE context information for configuring DRX operations in accordance with some aspects of the disclosure.

FIG. 16 is a diagram illustrating a handover method operable at a target base station utilizing UE context information in accordance with an aspect of the disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawing by various blocks, modules, components, circuits, steps, processes, algorithms, etc. (collectively referred to as “elements”). These elements may be implemented using electronic hardware, computer software, firmware or any combination thereof. Whether such elements are implemented as hardware or software depends upon the particular application and design constraints imposed on the overall system.

Aspects of the present disclosure provide methods and various apparatuses performing those methods to improve discontinuous reception (DRX) operations in RRC connected state and mobility management enhancement to achieve a suitable balance between DRX latency, power consumption, and handover success/failure rate in anticipation of an impending handover. Throughout this specification, CDRX refers to DRX in the RRC connected state, and CDRX and DRX may be used interchangeably. In DRX operations, a wireless user equipment (UE) may periodically depower or disable various power-hungry circuits, such as a power amplifier in a receiver, repowering or enable them at scheduled intervals to listen for incoming data or signaling messages. Enhancements of DRX operations can lead to more efficient power consumption and reduced handover failure.

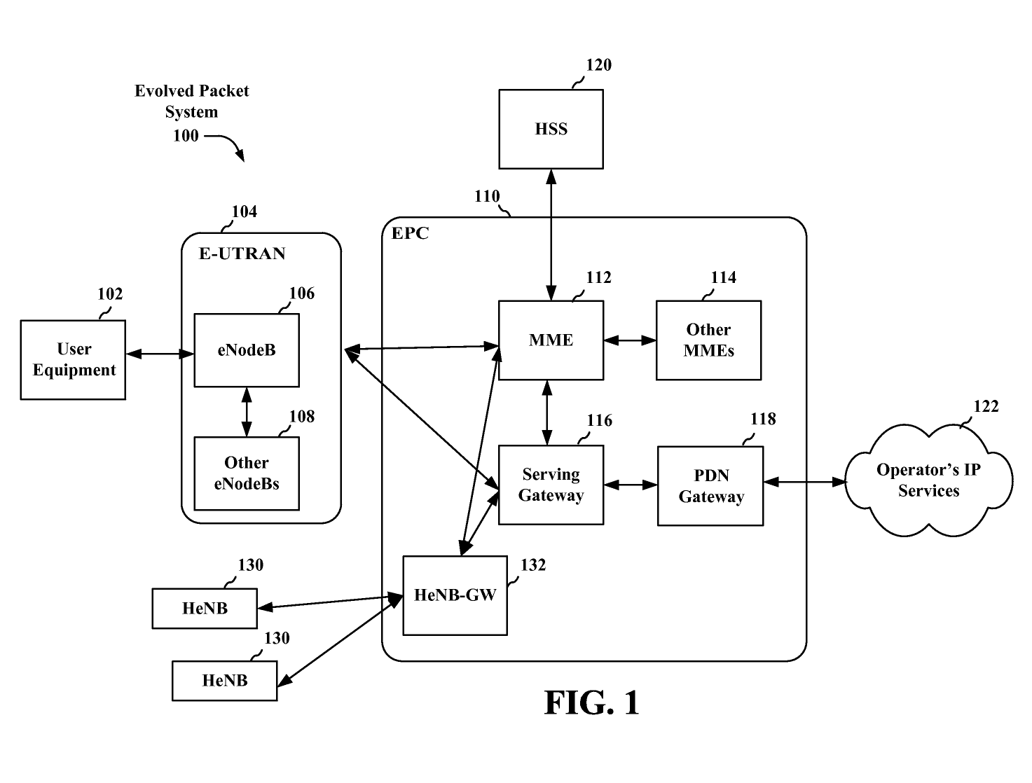

FIG. 1 is a diagram illustrating an LTE network architecture 100 employing various apparatuses. The LTE network architecture 100 may be referred to as an Evolved Packet System (EPS) 100. The EPS 100 may include one or more user equipment (UE) 102, an Evolved UMTS Terrestrial Radio Access Network (E-UTRAN) 104, an Evolved Packet Core (EPC) 110, a Home Subscriber Server (HSS) 120, and an Operator's IP Services 122. The EPS can interconnect with other access networks, but for simplicity those entities/interfaces are not shown. As shown, the EPS provides packet-switched services, however, as those skilled in the art will readily appreciate, the various concepts presented throughout this disclosure may be extended to networks providing circuit-switched services and other wireless networks.

The E-UTRAN 104 includes the evolved Node B (eNodeB or eNB) 106 and other eNBs 108. The eNB 106 provides user and control plane protocol terminations toward the UE 102. The eNB 106 may be connected to the other eNBs 108 via an X2 interface (i.e., backhaul). The eNB 106 may also be referred to by those skilled in the art as a base station, a base transceiver station, a radio base station, a radio transceiver, a transceiver function, a basic service set (BSS), an extended service set (ESS), a network access node, an access point, or some other suitable terminology. The eNB 106 provides an access point to the EPC 110 for a UE 102. Examples of UEs 102 include a cellular phone, a smart phone, a session initiation protocol (SIP) phone, a laptop, a tablet, a personal digital assistant (PDA), a satellite radio, a global positioning system, a multimedia device, a video device, a digital audio player (e.g., MP3 player), a camera, a game console, an activity tracker, an Internet-of-Things device, or any other similar functioning device. The UE 102 may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

The eNB 106 is connected by an S1 interface to the EPC 110. The EPC 110 includes a Mobility Management Entity (MME) 112, other MMEs 114, a Serving Gateway 116, and a Packet Data Network (PDN) Gateway 118. The MME 112 is the control node that processes the signaling between the UE 102 and the EPC 110. Generally, the MME 112 provides bearer and connection management. All user IP packets are transferred through the Serving Gateway 116, which itself is connected to the PDN Gateway 118. The PDN Gateway 118 provides UE IP address allocation as well as other functions. The PDN Gateway 118 is connected to the Operator's IP Services 122. The Operator's IP Services 122 include the Internet, the Intranet, an IP Multimedia Subsystem (IMS), and a PS Streaming Service (PSS). The EPS 100 may deploy a home eNodeB (e.g., HeNBs 130) that provide functions similar to the eNodeB 106, but is optimized for deployment for smaller coverage areas. The EPS 100 may include a HeNB Gateway 132 (HeNB-GW) connected between the HeNB 130 and the MME 112. The HeNB-GW 132 aggregates the traffic from a number of HeNBs 130.

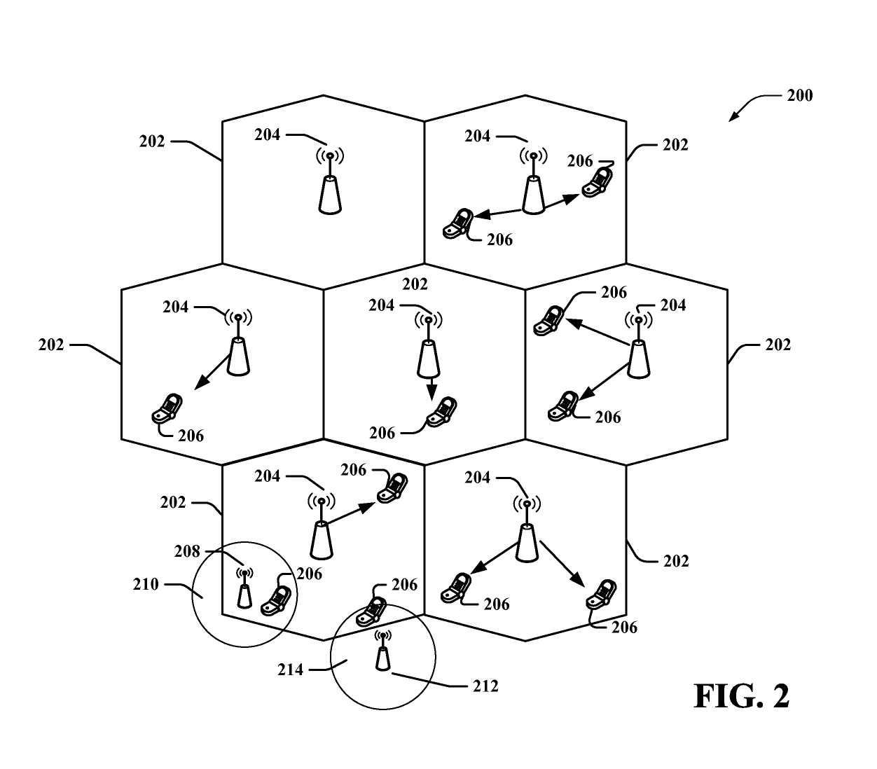

FIG. 2 is a diagram illustrating an example of an access network in an LTE network architecture. In this example, the access network 200 is divided into a number of cellular regions (cells) 202. One or more lower power class eNBs 208, 212 may have cellular regions 210, 214, respectively, that overlap with one or more of the cells 302. The lower power class eNBs 208, 212 may be femto cells (e.g., home eNBs (HeNBs)), pico cells, small cells, or micro cells. A higher power class or macro eNB 204 is assigned to a cell 202 and is configured to provide an access point to the EPC 110 for all the UEs 206 in the cell 202. There is no centralized controller in this example of an access network 200, but a centralized controller may be used in alternative configurations. The eNB 204 is responsible for all radio related functions including radio bearer control, admission control, mobility control, scheduling, security, and connectivity to the serving gateway 116 (see FIG. 1).

The modulation and multiple access scheme employed by the access network 200 may vary depending on the particular telecommunications standard being deployed. In LTE applications, OFDM is used on the DL and SC-FDMA is used on the UL to support both frequency division duplexing (FDD) and time division duplexing (TDD). As those skilled in the art will readily appreciate from the detailed description to follow, the various concepts presented herein are well suited for LTE applications. However, these concepts may be readily extended to other telecommunication standards employing other modulation and multiple access techniques. By way of example, these concepts may be extended to Evolution-Data Optimized (EV-DO) or Ultra Mobile Broadband (UMB). EV-DO and UMB are air interface standards promulgated by the 3rd Generation Partnership Project 2 (3GPP2) as part of the CDMA2000 family of standards and employs CDMA to provide broadband Internet access to mobile stations. These concepts may also be extended to Universal Terrestrial Radio Access (UTRA) employing Wideband-CDMA (W-CDMA) and other variants of CDMA, such as TD-SCDMA; Global System for Mobile Communications (GSM) employing TDMA; and Evolved UTRA (E-UTRA), Ultra Mobile Broadband (UMB), IEEE 802.11 (Wi-Fi), IEEE 802.16 (WiMAX), IEEE 802.20, and Flash-OFDM employing OFDMA. UTRA, E-UTRA, UMTS, LTE and GSM are described in documents from the 3GPP organization. CDMA2000 and UMB are described in documents from the 3GPP2 organization. The actual wireless communication standard and the multiple access technology employed will depend on the specific application and the overall design constraints imposed on the system.

The eNB 204 may have multiple antennas supporting MIMO technology. The use of MIMO technology enables the eNB 204 to exploit the spatial domain to support spatial multiplexing, beamforming, and transmit diversity.

Spatial multiplexing may be used to transmit different streams of data simultaneously on the same frequency. The data steams may be transmitted to a single UE 206 to increase the data rate or to multiple UEs 206 to increase the overall system capacity. This is achieved by spatially precoding each data stream (i.e., applying a scaling of an amplitude and a phase) and then transmitting each spatially precoded stream through multiple transmit antennas on the downlink. The spatially precoded data streams arrive at the UE(s) 206 with different spatial signatures, which enables each of the UE(s) 206 to recover the one or more data streams destined for that UE 206. On the uplink, each UE 206 transmits a spatially precoded data stream, which enables the eNB 204 to identify the source of each spatially precoded data stream.

Spatial multiplexing is generally used when channel conditions are good. When channel conditions are less favorable, beamforming may be used to focus the transmission energy in one or more directions. This may be achieved by spatially precoding the data for transmission through multiple antennas. To achieve good coverage at the edges of the cell, a single stream beamforming transmission may be used in combination with transmit diversity.

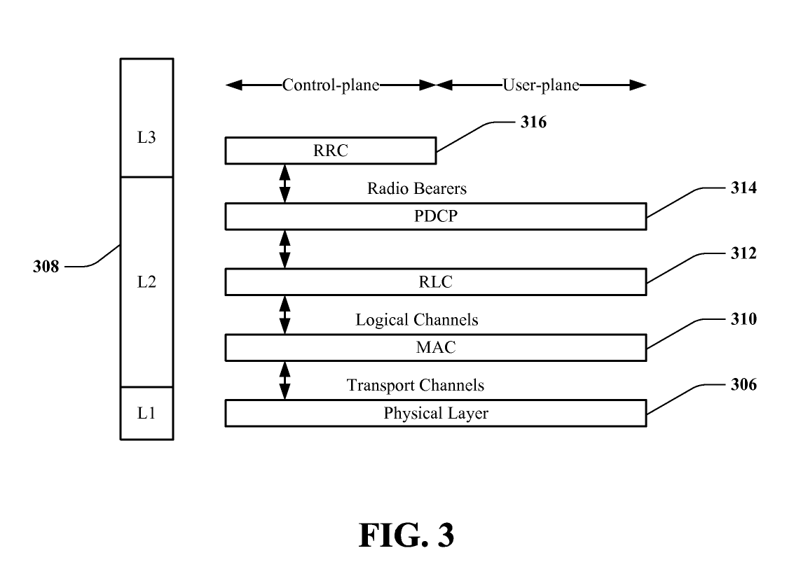

The radio protocol architecture may take on various forms depending on the particular application. An example for an LTE system will now be presented with reference to FIG. 3. FIG. 3 is a diagram illustrating an example of the radio protocol architecture for the user and control planes.

Turning to FIG. 3, the radio protocol architecture for the UE and the eNB is shown with three layers: Layer 1, Layer 2, and Layer 3. Layer 1 is the lowest layer and implements various physical layer signal processing functions. Layer 1 will be referred to herein as the physical layer 306. Layer 2 (L2 layer) 308 is above the physical layer 306 and is responsible for the link between the UE and eNB over the physical layer 306.

In the user plane, the L2 layer 308 includes a media access control (MAC) sublayer 310, a radio link control (RLC) sublayer 312, and a packet data convergence protocol (PDCP) 314 sublayer, which are terminated at the eNB on the network side. Although not shown, the UE may have several upper layers above the L2 layer 308 including a network layer (e.g., IP layer), and an application layer that is terminated at the other end of the connection (e.g., far end UE, server, etc.).

The PDCP sublayer 314 provides multiplexing between different radio bearers and logical channels. The PDCP sublayer 314 also provides header compression for upper layer data packets to reduce radio transmission overhead, security by ciphering the data packets, and handover support for UEs between eNBs. The RLC sublayer 312 provides segmentation and reassembly of upper layer data packets, retransmission of lost data packets, and reordering of data packets to compensate for out-of-order reception due to hybrid automatic repeat request (HARQ). The MAC sublayer 310 provides multiplexing between logical and transport channels. The MAC sublayer 310 is also responsible for allocating the various radio resources (e.g., resource blocks) in one cell among the UEs. The MAC sublayer 310 is also responsible for HARQ operations.

In the control plane, the radio protocol architecture for the UE and eNB is substantially the same for the physical layer 306 and the L2 layer 308 with the exception that there is no header compression function for the control plane. The control plane also includes a radio resource control (RRC) sublayer 316 in Layer 3. The RRC sublayer 316 is responsible for obtaining radio resources (i.e., radio bearers) and for configuring the lower layers using RRC signaling between the eNB and the UE.

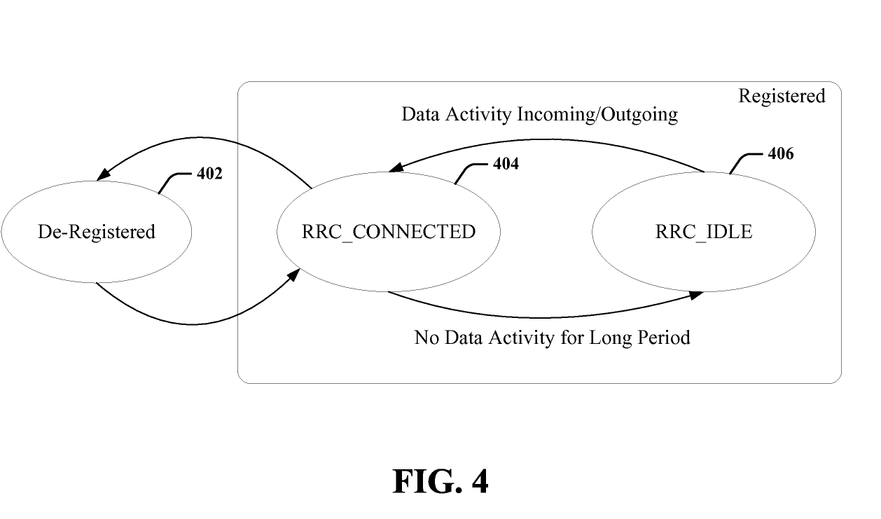

FIG. 4 is a diagram illustrating an example of LTE mobility management in accordance with some aspects of the disclosure. In an LTE network, a UE (e.g., UEs 102 and 206) is in a de-registered state 402 when it is first powered on. After registration with a network, the UE may be in either an RRC_Connected state 404 or an RRC_Idle state 406. In the RRC_Connected state 404, the UE can listen to the network and receive/transmit data. The UE transitions to the RRC_Idle state 406 after a certain period of data inactivity. For example, the network may configure an RRC Inactivity Timer to keep track of the time of data inactivity. The RRC Inactivity Timer may be set to a few seconds or a few tens of seconds in various examples. In the RRC_Idle state 406, the UE may consume less power than that of the RRC_Connected state 404. When the UE desires to receive or send data, it transitions back to the RRC_Connected state 404.

The UE may utilize one or more discontinuous reception (DRX) modes. One example of DRX variations is the LTE connected mode DRX (CDRX). When CDRX is enabled, the UE discontinuously receives data through one or more downlink channels such as a physical downlink shared channel (PDSCH). During CDRX, the UE remains in the RRC_Connected state 404. While CDRX may provide power savings, it also increases the latency (DRX latency) of the UE in responding to data transmission and/or signaling from the network because the UE can only response to the network when its receiver is enabled, and the data and/or signaling is received. Hereafter, reference of DRX refers to CDRX as an example.

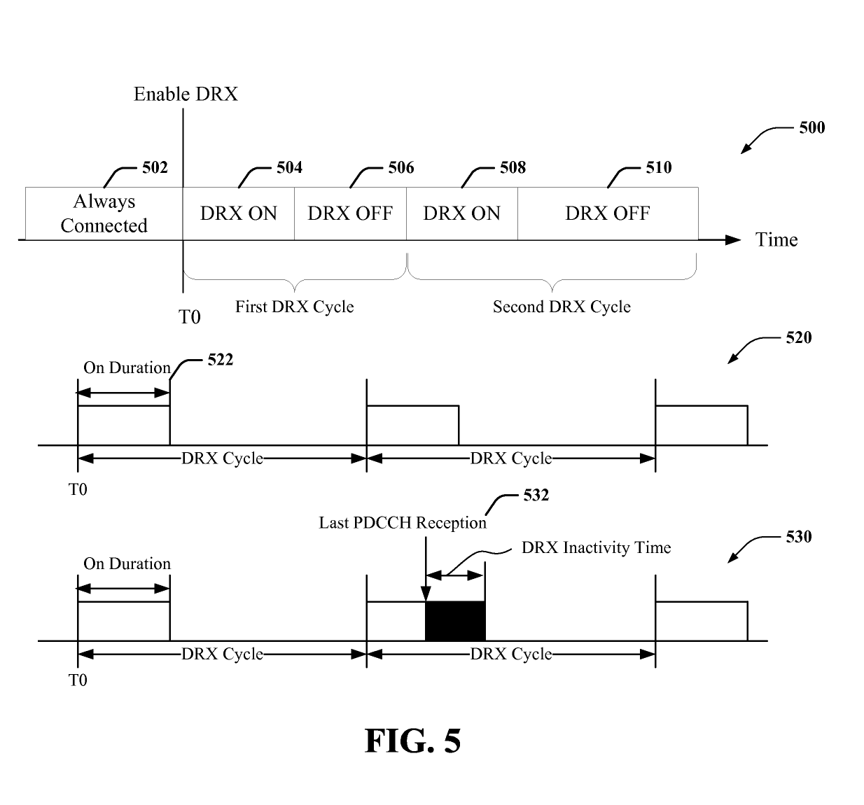

FIG. 5 is a diagram illustrating an example of a DRX timeline 500 in accordance with an aspect of the disclosure. The UE may be in an RRC_Connected state 404 when DRX is enabled. Referring to FIG. 5, a UE may be always connected (i.e., no DRX) with a serving eNB in a first period of time 502. At a certain time T0, the UE may be configured by the eNB to enable DRX to reduce power consumption. In LTE, the UE may support a short DRX cycle and a long DRX cycle. For example, the UE may enable DRX when user inactivity is detected or when no foreground data is detected. In some examples, foreground data may be data that is generated by user activity such as web browsing, instant messaging, emailing, streaming, etc.

A DRX cycle generally includes one or more DRX-on periods and DRX-off periods. In a DRX-off period, the UE may move to a low power state to disable or turn off various power-hungry circuits, such as an oscillator circuit, IF amplifier, and/or a mixer in a receiver. In a DRX-on period, the UE may move to the high power state to enable or turn on the power-hungry circuits to listen for incoming data and/or signaling messages. For example, a first DRX cycle may have a first DRX-on period 504 and a first DRX-off period 506. A second DRX cycle may have a second DRX-on period 508 and a second DRX-off period 510. In other examples, a DRX cycle may have one or more DRX-on and DRX-off periods. In general, the DRX cycle starts with one or more short DRX cycles and switches to a long DRX cycle if there is no data activity. In various aspects of the disclosure, the first and second DRX cycles may be the same or different. In some examples, the first DRX-on period 504 and second DRX-on period 508 may have the same or different time duration. In one example, the first DRX cycle may be a short DRX cycle, and the second DRX cycle may be a long DRX cycle. The first DRX-off period 506 and second DRX-off period 510 may have the same or different time duration. In some aspects of the disclosure, the first DRX cycle may be a short DRX cycle, and the second DRX cycle may be a long DRX cycle. The DRX-off period is longer in the long DRX cycle than that of the short DRX cycle. Therefore, the long DRX cycle may provide more power saving at the expense of increased DRX latency. More information on DRX in the LTE standard may be found for example in 3GPP Specification 36.321, 36.213, and 36.331, Release 12. These 3GPP documents are incorporated herein by reference.

In CDRX, the eNB (base station) determines and provides the UE with a set of DRX parameters for configuring the DRX cycles (e.g., long and/or short DRX cycles). The DRX configuration will be determined based on a tradeoff between power savings and DRX latency. In one aspect of the disclosure, the DRX parameters may be transmitted in a drx-config structure under the MAC-MainConfig Information Element (IE), which is transmitted in the RRCConnectionReconfiguratoin message. These DRX parameters for example include DRX-inactivity-timer, shortDRX-Cycle, drxShortCycleTimer, longDRX-CycleStartOffset, onDuration-Timer, and drx-RetransmissionTimer. In LTE, the DRX-inactivity-timer parameter specifies the number of consecutive PDCCH-subframe(s) for which UE should be active after successfully decoding a PDCCH indicating a new transmission (UL or DL). This timer is restarted upon receiving the PDCCH for a new transmission (UL or DL). Upon the expiration of this timer, the UE may enable DRX. Therefore, the UE may trigger or enable DRX when the DRX-inactivity-timer expires in the RRC_connected mode. In other aspects of the disclosure, an eNB may send a DRX command MAC control element (CE) to the UE. In response to such DRX command MAC CE, the UE may transition to the DRX-off state even before the DRX-inactivity-timer is expired.

The shortDRX-Cycle parameter indicates the length of the short DRX cycle (e.g., first DRX cycle of FIG. 5) in subframes which include a DRX-on period followed by a possible DRX-off (inactivity) period. The drxShortCycleTimer parameter indicates a timer value for example as multiples of shortDRX-Cycle. For example, this timer value may between from 1 to 16 (short DRX cycles). This timer indicates the number of the short DRX cycles before the UE enters the long DRX cycle. In the LTE examples, the short DRX cycle is the first type of DRX cycle (if configured) that is utilized when the UE enters DRX mode. The longDRX-CycleStartOffset parameter defines the long DRX cycle length (in number of subframes) as well as the DRX offset. The DRX offset is used to calculate the starting subframe number for DRX cycle and specifies the subframe where the DRX cycle starts.

The onDurationTimer parameter specifies the number of consecutive subframes of the DRX-on period during every DRX cycle before entering the power saving DRX-off period. For example, in LTE, this parameter indicates the number of PDCCH-subframe(s)) over which the UE reads the PDCCH during every DRX cycle before entering the power saving DRX-off period. The drx-RetransmissionTimer parameter indicates the maximum number of subframes for which the UE monitors the PDCCH when a retransmission from the eNB is expected by the UE. While the above-described DRX parameters are specific to LTE networks, different DRX parameters may be used in other aspects of the disclosure.

Aspects of the present disclosure provide various enhancements of DRX operations and mobility management of a UE. In some examples, a UE may provide certain DRX assistance information to an eNB to assist it in determining the suitable DRX parameters in different scenarios. In some aspects of the disclosure, the DRX assistance information may help the eNB to configure the UE such that a certain balance between DRX latency and power consumption may be achieved. In some aspects of the disclosure, the enhancements may help reduce handover or handout failures of the UE and improve mobility management. In particular examples, the disclosed enhancements of DRX operations and mobility management of a UE can reduce handover failures when the UE is moving from a small cell or pico cell (e.g., HeNB) to a micro cell (e.g., eNB).

Referring to FIG. 5, a DRX time line 520 illustrates that the UE stays on during a DRX ON state 522 until the DRX ON duration timer (e.g., onDurationTimer) expires. In this particular example, the UE does not receive a PDCCH transmission directed to it. In another example, a DRX time line 530 illustrates that the UE successfully receives a PDCCH transmission 532 directed to it. Therefore, from the point the UE receives the last PDCCH transmission 532, the UE stays in the DRX ON state until its DRX inactivity timer expires. Thus, the DRX ON duration gets extended in this case.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

The software may reside on a computer-readable medium or a computer-readable storage medium. The computer-readable medium may be a non-transitory computer-readable medium. A non-transitory computer-readable medium include, by way of example, a magnetic storage device (e.g., hard disk, floppy disk, magnetic strip), an optical disk (e.g., compact disk (CD), digital versatile disk (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, a removable disk, and any other suitable medium for storing software and/or instructions that may be accessed and read by a computer. The computer-readable medium may be resident in the processing system, external to the processing system, or distributed across multiple entities including the processing system. The computer-readable medium may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

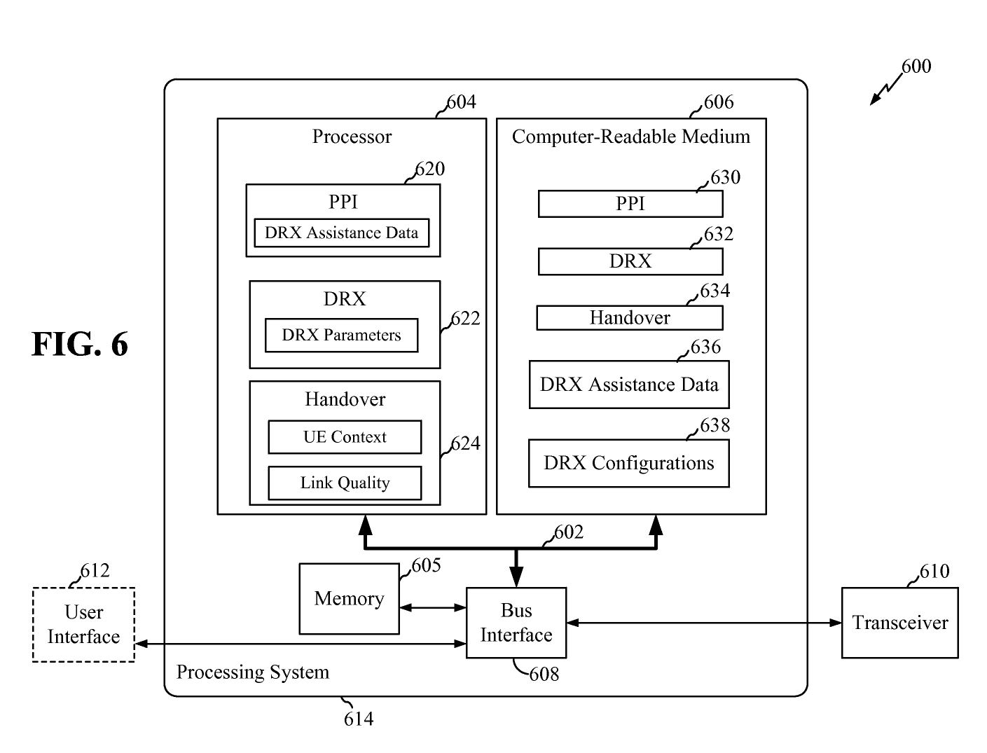

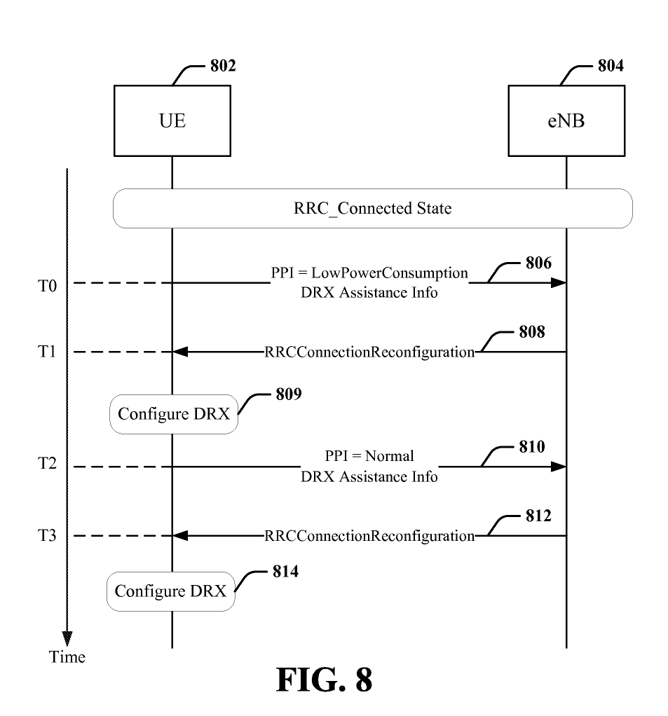

FIG. 6 is a diagram illustrating an example of a hardware implementation for an apparatus 600 employing a processing system 614. In accordance with various aspects of the disclosure, an element, or any portion of an element, or any combination of elements may be implemented with a processing system 614 that includes one or more processors 604. In some examples, the apparatus 600 may be a user equipment (UE) as illustrated in any one or more of FIGS. 1, 2, 7, 8, 11, and 13. In some examples, the apparatus 600 may be an eNB as illustrated in any one or more of FIGS. 1, 2, 7, 8, 11, and 13. Examples of processors 604 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. That is, the processor 604, as utilized in an apparatus 600, may be used to implement any one or more of the processes and methods described below and illustrated in FIGS. 8-16.

In this example, the processing system 614 may be implemented with a bus architecture, represented generally by the bus 602. The bus 602 may include any number of interconnecting buses and bridges depending on the specific application of the processing system 614 and the overall design constraints. The bus 602 links together various circuits including one or more processors (represented generally by the processor 604), a memory 605, and computer-readable media (represented generally by the computer-readable medium 606). The bus 602 may also link various other circuits such as timing sources, peripherals, voltage regulators, and power management circuits, which are well known in the art, and therefore, will not be described any further. A bus interface 608 provides an interface between the bus 602 and a transceiver 610. The transceiver 110 (e.g., a communication interface) provides a means for communicating with various other apparatus over a transmission medium. Depending upon the nature of the apparatus, a user interface 612 (e.g., keypad, display, speaker, microphone, joystick, touchscreen, touchpad) may also be provided.

In some aspects of the disclosure, the processor 604 may include a power preference indication (PPI) block 620, a discontinuous reception (DRX) block 622, and a handover block 624. The PPI block 620 may be configured to perform functions related to PPI requests for changing DRX configuration, which will be described in detail in relation to FIGS. 8-10 below. The DRX block 622 may be configured to perform various DRX related operations in connection with other components of the apparatus 600 (e.g., memory 605, computer-readable medium 606, and transceiver 610). The DRX block 622 will be described in detail in relation to FIGS. 8-16 below.

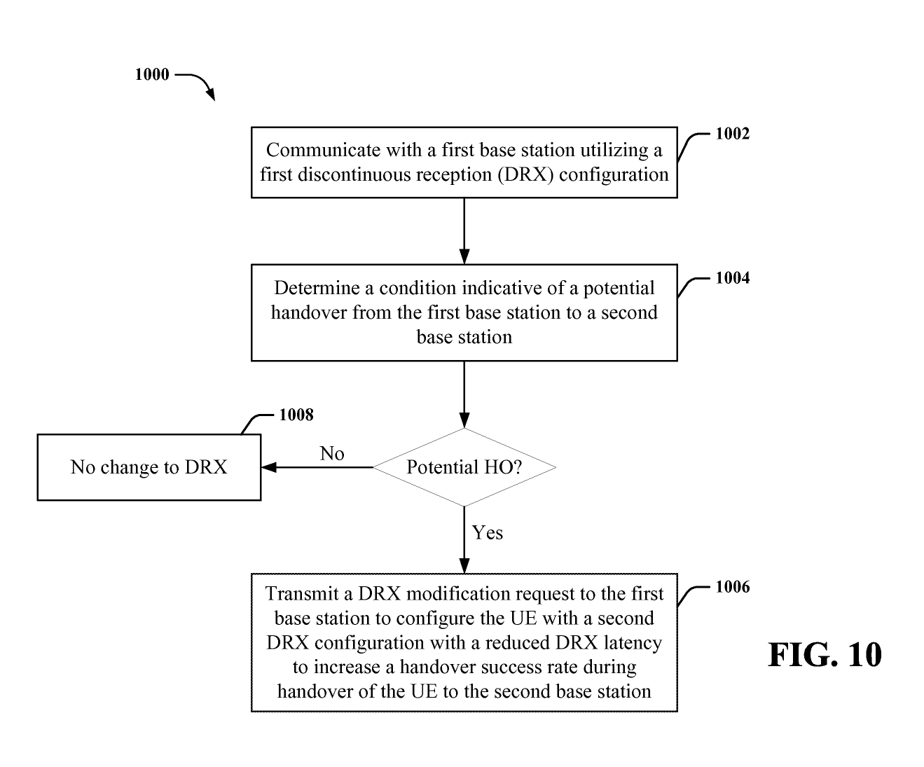

The handover block 624 may be configured to perform various functions related to handover operations in connection with other components of the apparatus 600. The handover block 624 will be described in detail in relation to FIGS. 10-14 below. In wireless telecommunications, handover or handout refers to the process of transferring an ongoing call or data session from one base station to another base station without loss or interruption of service. In various examples, the handover may be performed between base stations of the same communication network or different networks. A UE may communicate with the base stations utilizing the same radio access technology (RAT) or different RATs. Some non-limiting examples of RATs include UMTS, LTE, CDMA2000, WiFi, Bluetooth, etc.

In some aspects of the disclosure, when the processing system 614 is implemented as a UE, the DRX block 622 may receive a plurality of DRX parameters from a base station and configure a DRX operation based on the received DRX parameters. In some aspects of the disclosure, the DRX block 622 may be utilized to select a DRX configuration among a plurality of predetermined DRX configurations. A DRX configuration specifies how a UE is configured to perform DRX operations according to a certain set of DRX parameters. In some aspects of the disclosure, the DRX configuration being configured at the apparatus 600 and other relevant information and settings may be included in UE context information. In some aspects of the disclosure, the PPI block 620 may be utilized to transmit DRX assistance data associated with the PPI request to a base station (e.g., eNB), for assisting the base station in determining a plurality of DRX parameters.

In some aspects of the disclosure, the handover block 624 may be utilized to determine a condition indicative of a potential handover from a first base station (e.g., source eNB) to a second base station (e.g., target eNB). The condition indicative of a potential handover refers to a situation wherein there is a high probability that the apparatus 600 may perform a handover from the source eNB to one or more target eNBs that the apparatus is monitoring in order to maintain its communication link with the network. The probability may be determined based on the relative signal strength and/or quality among the cells. The handover may be an inter-frequency handover, an intra-frequency handover, and/or an inter-RAT handover. In some examples, the apparatus 600 (UE) may determine the possibility or probability of a handover by comparing the link quality between the apparatus 600 and the current source cell/sector, and the link quality between the apparatus 600 and other available target cells/sectors. In cellular networks, when a UE moves from cell to cell and performs cell selection/reselection and handover, it measures the signal strength and/or quality of the neighbor cells prior to performing handover. In the LTE network, for example, the apparatus 600 may measure two parameters on reference signal: RSRP (Reference Signal Received Power) and RSRQ (Reference Signal Received Quality). In general, a handover condition may be determined by certain thresholds that are configured by the source eNB or base station. The thresholds may be in terms of RSRP, RSRQ, or both. In some examples, there may be thresholds for triggering intra-frequency or inter-frequency cell search. The UE may also consider thresholds for the target cell for handover determination. In addition, the UE may choose an internal threshold which is more conservative than those of the eNBs. Therefore, when one or more of the thresholds are met, the apparatus 600 may consider this as a condition indicative of a potential handover. In one particular example, when the RSRP and/or RSRQ of a neighbor cell or sector is greater than that of the serving cell or sector by a certain threshold, it may be considered as a condition indicative of a potential handover.

In some aspects of the disclosure, the apparatus 600 when configured as an eNB (e.g., a source eNB or base station), may transmit UE context information for the UE undergoing handover relating to DRX configuration (e.g., a current DRX configuration) to the target base station (e.g., a target eNB). In response, the target base station can determine and configure the UE to utilize a suitable DRX configuration among a plurality of predetermined DRX configurations. In one particular example, the target base station may configure the apparatus 600 to use the same DRX configuration after handover as configured by the source base station before the handover.

The processor 604 is also responsible for managing the bus 602 and general processing, including the execution of software stored on the computer-readable medium 606. The software, when executed by the processor 604, causes the processing system 614 to perform the various functions described below for any particular apparatus. The computer-readable medium 606 may also be used for storing data that is manipulated by the processor 604 when executing software.

In some aspects of the disclosure, the computer-readable medium 606 stores a number of routines, executable code, and data, which when executed or utilized by the processor 604 configures the processor 604 to perform the function described in FIGS. 8-16. For example, the computer-readable medium 606 stores a PPI routine 630, DRX routine 632, a handover routine 634, DRX assistance data 636, and DRX configurations 638. These components will be described in detail in relation to FIGS. 8-16.

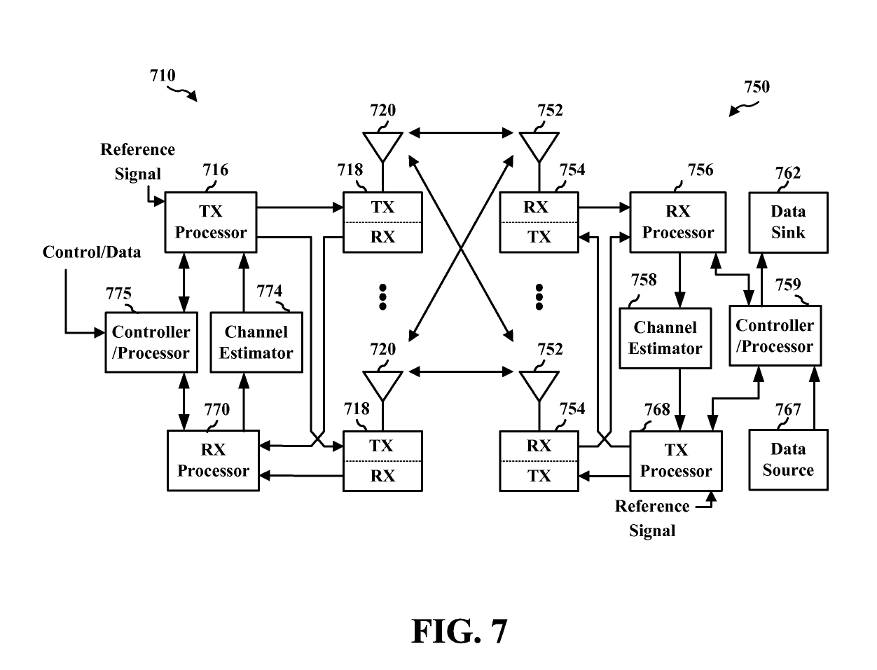

FIG. 7 is a block diagram of an eNB 710 in communication with a UE 750 in an access network. The eNB 710 may be any of the eNBs illustrated in FIGS. 1,2, 6, 8, 11, and 13. The UE 750 may be any of the UEs illustrated in FIGS. 1, 2, 6, 8, 11, and 13. In the DL, upper layer packets from the core network are provided to a controller/processor 775. The controller/processor 775 implements the functionality of the L2 layer described earlier in connection with FIG. 3. In the DL, the controller/processor 775 provides header compression, ciphering, packet segmentation and reordering, multiplexing between logical and transport channels, and radio resource allocations to the UE 750 based on various priority metrics. The controller/processor 775 is also responsible for HARQ operations, retransmission of lost packets, and signaling to the UE 750.

The TX processor 716 implements various signal processing functions for the L1 layer (i.e., physical layer). The signal processing functions includes coding and interleaving to facilitate forward error correction (FEC) at the UE 750 and mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols are then split into parallel streams. Each stream is then mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 774 may be used to determine the coding and modulation scheme, as well as for spatial processing. The channel estimate may be derived from a reference signal and/or channel condition feedback transmitted by the UE 750. Each spatial stream is then provided to a different antenna 720 via a separate transmitter 718TX. Each transmitter 718TX modulates an RF carrier with a respective spatial stream for transmission.

At the UE 750, each receiver 754RX receives a signal through its respective antenna 752. Each receiver 754RX recovers information modulated onto an RF carrier and provides the information to the receiver (RX) processor 756.

The RX processor 756 implements various signal processing functions of the L1 layer. The RX processor 756 performs spatial processing on the information to recover any spatial streams destined for the UE 750. If multiple spatial streams are destined for the UE 750, they may be combined by the RX processor 756 into a single OFDM symbol stream. The RX processor 756 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, is recovered and demodulated by determining the most likely signal constellation points transmitted by the eNB 710. These soft decisions may be based on channel estimates computed by the channel estimator 758. The soft decisions are then decoded and deinterleaved to recover the data and control signals that were originally transmitted by the eNB 710 on the physical channel. The data and control signals are then provided to the controller/processor 759. The eNB 710 and UE 750 may communicate with each other utilizing DRX and control DRX as described in relation to FIGS. 8-14 below.

The controller/processor 759 implements the L2 layer described earlier in connection with FIG. 3. In the UL, the control/processor 759 provides demultiplexing between transport and logical channels, packet reassembly, deciphering, header decompression, control signal processing to recover upper layer packets from the core network. The upper layer packets are then provided to a data sink 762, which represents all the protocol layers above the L2 layer. Various control signals may also be provided to the data sink 762 for L3 processing. The controller/processor 759 is also responsible for error detection using an acknowledgment (ACK) and/or negative acknowledgment (NACK) protocol to support HARQ operations.

In the UL, a data source 767 is used to provide upper layer packets to the controller/processor 759. The data source 767 represents all protocol layers above the L2 layer (L2). Similar to the functionality described in connection with the DL transmission by the eNB 710, the controller/processor 759 implements the L2 layer for the user plane and the control plane by providing header compression, ciphering, packet segmentation and reordering, and multiplexing between logical and transport channels based on radio resource allocations by the eNB 710. The controller/processor 759 is also responsible for HARQ operations, retransmission of lost packets, and signaling to the eNB 710.

Channel estimates derived by a channel estimator 758 from a reference signal or feedback transmitted by the eNB 710 may be used by the TX processor 468 to select the appropriate coding and modulation schemes, and to facilitate spatial processing. The spatial streams generated by the TX processor 768 are provided to different antenna 752 via separate transmitters 754TX. Each transmitter 754TX modulates an RF carrier with a respective spatial stream for transmission.

The UL transmission is processed at the eNB 710 in a manner similar to that described in connection with the receiver function at the UE 750. Each receiver 718RX receives a signal through its respective antenna 720. Each receiver 718RX recovers information modulated onto an RF carrier and provides the information to an RX processor 770. The RX processor 770 implements the L1 layer.

The controller/processor 759 implements the L2 layer described earlier in connection with FIG. 3. In the UL, the control/processor 759 provides demultiplexing between transport and logical channels, packet reassembly, deciphering, header decompression, control signal processing to recover upper layer packets from the UE 750. Upper layer packets from the controller/processor 775 may be provided to the core network. The controller/processor 759 is also responsible for error detection using an ACK and/or NACK protocol to support HARQ operations.

In some aspects of the disclosure, the processing system 614 described in relation to FIG. 6 includes the eNB 710. In particular, the processing system 614 may include the TX processor 716, the RX processor 770, and the controller/processor 775. In some aspects of the disclosure, the processing system 614 described in relation to FIG. 6 includes the UE 750. In particular, the processing system 614 may include the TX processor 768, the RX processor 756, and the controller/processor 759.

Some aspects of the disclosure provide an enhanced PPI mechanism to enhance the assistance information that a UE provides to an eNB when the UE transmits a PPI request. In the related art, the known PPI mechanism provides a limited amount of information to an eNB for assisting DRX configuration. For example, the known PPI mechanism does not adequately inform the eNB what actions to perform regarding DRX configuration, and does not adequately account for different types of background traffic and occasional foreground traffic in setting DRX configuration.

In one aspect of the disclosure, within a UEAssistanceInformation message that has the PowerPrefIndication-r11 information element set to LowPowerConsumption, the UE may also provide additional DRX related information to the eNB. Specifically, the UE may include DRX assistance information to assist the eNB in configuring the DRX operation according to the current scenario of the UE to achieve a certain power consumption and DRX latency tradeoff.

FIG. 8 is a diagram illustrating the communication between a UE 802 and an eNB 804 utilizing power preference indication (PPI) messages and DRX assistance information to configure DRX operations in accordance with some aspects of the disclosure. Some generally known DRX operations at the UE 802 and/or the eNB 804 may be omitted in FIG. 8 to avoid obscuring the disclosure. The UE 802 may be a UE illustrated in any one or more of FIGS. 1, 2, 6, 7, 11, and 13 or any suitable apparatus. The eNB 804 may be an eNB illustrated in any one or more of FIGS. 1, 2, 6, 7, 11, and 13 or any suitable apparatus. At certain time, the UE 802 and eNB 804 may be communicating with each other in an RRC_Connected state. Before the time point T0, when the data traffic (including foreground and/or background data) between the UE 802 and eNB 804 is less than a certain threshold level for a predetermined period of time, a DRX inactivity timer (e.g., DRX-inactivity-timer) of the UE may expire. When the DRX inactivity timer expires, the eNB 804 may configure the UE 802 to operate in the DRX mode in a first DRX configuration. Different from the known PPI mechanism, the UE may assist the eNB in configuring the DRX mode by providing the eNB with assistance information regarding the DRX configuration to be configured or requested. Therefore, in one aspect of the disclosure, the UE 802 may signal or transmit a PPI request 806 (a DRX modification request) by transmitting an RRC message called UEAssistanceInformation message to the eNB 804 in order to reconfigure the UE 802 to a DRX configuration that may consume less power (e.g., LowPowerConsumption). However, in some aspect of the disclosure, the eNB 804 is not obliged to configure the UE with the requested DRX configuration as signaled by the PPI request 806. In some aspects of the disclosure, the eNB 804 may ignore the PPI request 806 or configure the UE with a different DRX configuration.

In one example, the UE 802 may utilize a PPI block 620 of FIG. 6 to transmit the PPI request 806 based on the UE's current or anticipated data activity to request a change to the DRX configuration. The amount of data traffic between the UE 802 and the eNB 804 may depend on the user activities at the UE. For examples, web browsing, video telephone, online gaming, media streaming, media downloading, and other similar data intensity activities can generate significant amount of data traffic (e.g., foreground data) between the UE and eNB. Other types of user activities such as texting, instant messaging, and other low bandwidth activities, generate less amount of data traffic between the UE and eNB. In one particular example, when there is no foreground data between the UE and eNB, the UE 802 is in the background mode (i.e., user inactive), and detection of such background mode may trigger the PPI request 806.

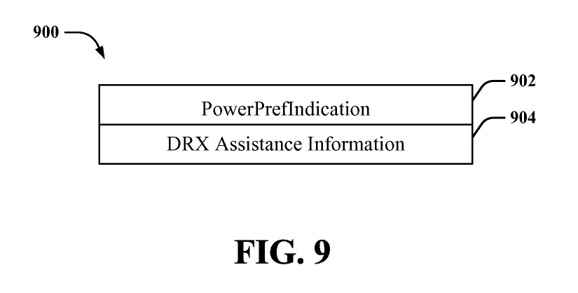

FIG. 9 is a diagram illustrating a powerPrefIndicationConfig information element (IE) 900 that may be used to transmit the UEAssistanceInformation message 806 (PPI request) to the eNB 804. The powerPrefIndicationConfig IE 900 includes a PowerPrefIndication field 902 (or PowerPrefIndication-r11 in some examples) that may be set to a LowPowerConsumption state to indicate that the UE 802 prefers a configuration that may lead to more power savings. The PowerPrefIndication field 902 may also be set to a normal state to indicate that the UE 802 prefers a configuration that may reduce DRX latency and possibly higher power consumption. In some examples, the UEAssistanceInformation message may be a one-bit message (e.g., bit 1 for a LowPowerConsumption state and bit 0 for a normal state). In other aspects of the disclosure, the UEAssistanceInformation message may indicate two or more states for example using two or more bits. For example, the UEAssistanceInformation message may indicate an ultra-low power state that allows the UE to be configured to use less power than that of the LowPowerConsumption state.

In one aspect of the disclosure, the UEAssistanceInformation message 806 may include DRX assistance information that can assist the eNB 804 to determine the DRX parameters for configuring the UE 802. In one example, the UE 802 may utilize the PPI block 620 in connection with the transceiver 610 to transmit the DRX assistance information to the eNB 804. Non-limiting examples of DRX assistance data may include one or more values corresponding to the DRX parameters including for example DRX-inactivity-timer, shortDRX-Cycle, drxShortCycleTimer, longDRX-CycleStartOffset, onDuration-Timer, and drx-RetransmissionTimer. In one aspect of the disclosure, the powerPrefIndicationConfig IE 900 may include a DRX Assistance Information field 904 that includes the DRX assistance information. In some aspects of the disclosure, the UE 802 may transmit the DRX assistance information in a separate IE or message different from the UEAssistanceInformation message 806 (PPI request).

Still referring to FIG. 8, at a time point T1, the eNB 804 may respond to the PPI request 806 with an RRCConnectionReconfiguration message 808. The eNB 804 utilizes the RRCConnectionReconfiguration message 808 to reconfigure the RRC connection between the UE 802 and eNB 804. For example, the RRCConnectionReconfiguration message 808 can be used to establish/modify/release radio bearers, perform handover, setup/modify/release measurements, add/modify/release secondary cells, transfer dedicated Non-Access Stratum (NAS) Information to the UE 802. In an aspect of the disclosure, the eNB 804 may utilize the RRCConnectionReconfiguration message 808 to provide the UE 802 with certain DRX parameters for a DRX configuration that may reduce UE power consumption. To that end, the eNB 804 may consider the DRX assistance information associated with the PPI request 806 when it determines the suitable DRX parameters. In one particular example, the eNB 804 may provide the UE 802 with a smaller value for the DRX-inactivity-timer, a larger value for shortDRX-Cycle and/or longDRX-CycleStartOffset, and/or a smaller value for the onDuration-Timer. In one aspect of the disclosure, when the eNB 804 is implemented with an apparatus 600, it may utilize the DRX block 622 to determine the DRX parameters, and the transceiver 610 to transmit the RRCConnectionReconfiguration message 808 to the UE.

In response to the RRCConnectionReconfiguration message 808, the UE 802 may configure its DRX operations 809 (e.g., a first DRX configuration) based on the DRX parameters in the RRCConnectionReconfiguration message 808. When the UE 802 is implemented with the apparatus 600, it may utilize the communication interface 610 to receive the RRCConnectionReconfiguration message 808 and the DRX block 622 to reconfigure its DRX operations based on the received DRX parameters.

At a certain time before the time point T2, the UE 802 may have or anticipate increased data activity (background and/or foreground data) with the eNB 804. Therefore, at the time point T2, the UE 802 may signal another PPI request 810 by transmitting a UEAssistanceInformation message to the eNB 804. In this case, the UE 802 may set the powerPrefIndication field 902 to normal in the UEAssistanceInformation message 810. In one aspect of the disclosure, the UEAssistanceInformation message 810 may include DRX assistance information that can assist the eNB 804 to determine suitable DRX parameters for configuring the UE 802 to reduce its DRX latency in a second DRX configuration. In some examples, the UE 802 may transmit the DRX assistance information in a separate IE or message that is different from the UEAssistanceInformation message 810.

In response to the PPI request 810, at a time point T3, the eNB 804 may respond to the PPI request 810 with an RRCConnectionReconfiguration message 812 that provide the UE 802 with certain DRX parameters that may reduce its DRX latency. In one example, the RRCConnectionReconfiguration message 812 may provide the UE 802 with a larger value for the DRX-inactivity-timer, a smaller value for the shortDRX-Cycle and longDRX-CycleStartOffset, and/or a larger value for the onDuration-Timer. In response, the UE 802 can configure 814 its DRX operations (e.g., a second DRX configuration) based on the DRX parameters received from the RRCConnectionReconfiguration message 812.

In some aspects of the disclosure, a UE illustrated in one or more of FIGS. 1, 2, 6, 7, 11, and 13 may monitor the link quality with its serving cell (e.g., source eNB) and neighboring cells (e.g., target eNBs) in anticipation of a handover. For example, in LTE, the UE may additionally receive system information from these neighbor cells/eNBs in System Information Block (SIB) broadcasts, which indicates whether the neighbor cell is a macrocell or a small cell. SIBs also carry relevant information for the UE such as information related to intra-frequency, inter-frequency and inter-RAT cell selections, which help the UE to access a cell and perform cell re-selection if needed. For example, in LTE, the UE receives a Master Information Block (MIB) over a Physical Broadcast Channel (PBCH). The UE also receives SIBs from a Physical Downlink Shared Channel (PDSCH), which is a data bearing channel allocated to users on a dynamic and opportunistic basis.

Accordingly, when the UE is anticipating a handover or handout (e.g., a handover from a small cell to a macrocell), the UE may transmit certain assistance information to the source eNB. Such assistance information requests or prompts the eNB to configure the UE for a DRX configuration that can reduce its DRX latency such that the handover failure rate may be reduced. For example, during a handover from a pico cell (e.g., HeNB) to a micro cell, the UE may be leaving the pico cell at a high speed with a long DRX cycle. In this case, the handover failure rate may be undesirable high. According to aspects of the disclosure, the UE can request the source eNB to reduce the DRX cycle in anticipation of a possible handover such that the handover failure rate may be reduced. In one particular example, the UE assistance information may be an RRC message UEAssitanceInformation with the field PowerPrefIndication set to normal.

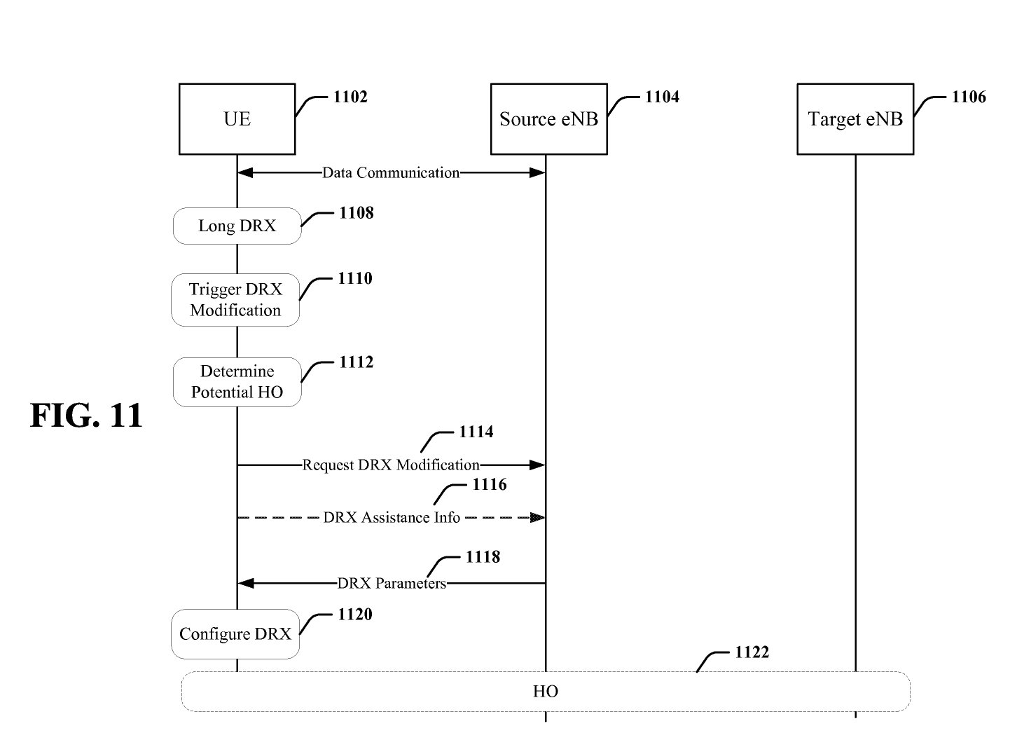

FIG. 10 is a flow chart illustrating a DRX control method 1000 operable at a UE in anticipation of a handover in accordance with some aspects of the disclosure. The method 1000 may be performed by a UE illustrated in any one or more of FIGS. 1, 2, 6, 7, 11, and 13 or any suitable apparatus. In a particular example, the UE 1102 (see FIG. 11) may perform the method 1000 in an RRC_Connected state in communication with an eNB 1104. Referring to FIG. 10, at block 1002, the UE communicates with a first base station (e.g., a source eNB) utilizing a DRX configuration (e.g., a first DRX configuration) in a DRX mode. In one aspect of the disclosure, when implemented as an apparatus 600, the UE may utilize the transceiver 610 and DRX block 622 (see FIG. 6) to communicate with the first base station utilizing DRX. The first base station may be a source eNB illustrated in any one or more of FIGS. 1, 2, 6, 7, 11, and 13. At block 1004, the UE may determine a condition indicative of a potential handover from the first base station to a second base station (e.g., a target eNB). In one example, the UE may utilize the handover block 624 (see FIG. 6) to determine the condition indicative of a potential handover. The second base station may be a target eNB illustrated any one or more of FIGS. 1, 2, 6, 7, 11, and 13. In one particular example, the second base station may be a target eNB 1106 (see FIG. 11).

To determine a potential handover condition, the UE may measure and compare the quality of its serving cells and neighbor cells to determine whether or not a potential handover or handout condition exists as described above. The UE may consider various thresholds that are configured by the source eNB to determine the potential handover. In some examples, the thresholds may be in terms of RSRP, RSRQ, and/or other suitable characteristics of the serving cell and neighbor cell. In one particular example, the UE may measure and compare the respective RSRP and/or RSRQ of the cells. When one or more of the measured parameters or thresholds of a neighbor cell (e.g., target eNB) are better than that of the serving cell (e.g., a source eNB), the UE may determine that a potential handover condition exists. However, this potential handover condition may or may not trigger an actual handover. If the condition indicative of the potential handover exists, the method 1000 proceeds to block 1006; otherwise, the method proceeds to block 1008. At block 1006, the UE may transmit a DRX modification request to the first base station to configure the UE with a different DRX configuration (e.g., a second DRX configuration) with a reduced DRX latency (e.g., a shorter DRX cycle) to increase a handover success rate during handover of the UE to the second base station. By reducing the DRX latency in anticipation of a potential handover, the UE may reduce its handover failure rate. In one example, the UE may utilize the PPI block 620 (see FIG. 6) to transmit the DRX modification request via a PPI message that contains DRX assistance data for a shorter DRX cycle. The DRX assistance data may include information for configuring a certain DRX configuration or an indication (e.g., an index value) of a DRX configuration among a number of predetermined DRX configurations that are known to the base station. In one particular example, the UE may request the eNB to take it out of DRX (disable DRX) such that latency due to DRX may be avoided. In some aspects of the disclosure, the UE may request a change of DRX configuration by transmitting a DRX command MAC Control Element (CE), which may specify one of a number of predetermined DRX configurations that are known to the base station. Otherwise, at block 1008, the UE makes no request to change the current DRX configuration.

In some aspects of the disclosure, the UE may utilize the PPI block 620 and the transceiver 610 to transmit the DRX modification request via an RRC message. In other aspects of the disclosure, the UE may utilize the DRX block 622 and the transceiver 610 to transmit the DRX modification request as an MAC Control Element (CE) to indicate the desired DRX configuration (e.g., a predetermined or preconfigured DRX configuration). In one aspect of the disclosure, the UE may transmit the DRX modification request by utilizing the RRC signaling procedures illustrated in FIG. 8. In this particular example, the DRX modification request may be a PPI request that is transmitted to a source eNB or base station to request a DRX configuration change in order to reduce DRX latency. In some examples, the UE may signal a PPI request by transmitting a UEAssistanceInformation message 810 with the powerPrefIndication field set to normal. In response, the eNB may disable DRX or change one or more DRX parameters to reduce DRX latency. In some aspects of the disclosure, the UE may also utilize the PPI block 620 (see FIG. 6) to transmit DRX assistance data with the UEAssistanceInformation message to assist the serving eNB in determining suitable DRX parameters for configuring the UE to reduce DRX latency. In some examples, the DRX assistance information may include one or more of DRX-inactivity-timer, shortDRX-Cycle, drxShortCycleTimer, longDRX-CycleStartOffset, onDuration-Timer, and drx-RetransmissionTimer.

In some aspects of the disclosure, the UE may be configured to utilize one of a plurality of predetermined or preconfigured DRX configurations. For example, the UE may store the predetermined DRX configurations 638 at the computer-readable medium 606. An active DRX configuration is the one that the UE is currently configured with. The predetermined DRX configurations may be selected and utilized for different quality of service (QoS) and mobility scenarios. For example, each DRX configuration may be configured for a certain QoS and mobility scenario combination. Some non-limiting examples of the different QoS and mobility scenarios combinations are: background data mode, no handover (HO) anticipated; background data mode, HO anticipated; background data mode with intermittent foreground activity, no HO anticipated; background data mode with intermittent foreground activity, HO anticipated. When HO is anticipated, a DRX configuration may be selected to reduce DRX latency. When the UE is in the background data mode, a DRX configuration may be selected to reduce power consumption. The selection of a particular DRX configuration based on a certain QoS and mobility scenario combination may be a design tradeoff between the desired DRX latency, power consumption, and handover success/failure rate.

In the background data mode, the UE has no or low level of foreground activity with the eNB. In the background data mode, the user of the UE may not be interacting with the UE (i.e., user inactive). In one aspect of the disclosure, the DRX modification request may be configured to request the eNB to switch the UE from a first predetermined DRX configuration to a second predetermined DRX configuration based on the QoS and mobility scenarios so as to achieve a suitable DRX latency, power consumption, and handover success/failure rate.in anticipation of an impending handover.

FIG. 11 is a diagram illustrating an example implementation of the DRX control method 1000 in accordance with some aspects of the disclosure. By way of example, a UE 1102 is in communication with a source eNB 1104. The UE 1102 may be a UE illustrated in any one or more of FIGS. 1, 2, 6, 7, and 13. The source and target eNBs may an eNB illustrated in any one or more of FIGS. 1, 2, 6, 7, and 13. Initially, the UE 1102 is in an RRC connected state communicating with the network via the source eNB 1104. The UE is configured for DRX with a large or long DRX cycle 1108 due to detection of a background mode to achieve low power consumption. The UE 1102 may be configured for mobility related measurement reports by the source eNB 1104 (e.g., outbound handover from the source eNB 1104 to the target eNB 1106), and the UE 1102 may have internal thresholds for triggering DRX modification requests 1110 if the current configured DRX cycle is greater than a certain threshold. The threshold may be provisioned by the network operator or based on a satisfactory handover success rate (or failure rate). For example, based on the measured signal quality of the source eNB 1104 and target eNB 1106, the UE 1102 may determine 1112 a condition indicative of a potential handover from the source eNB 1104 (a first base station) to the target eNB 1106 (a second base station) as described above in relation to FIG. 10. At a certain time when the threshold for triggering DRX modification request is satisfied, the UE 1102 may transmit a DRX modification request 1114 in anticipation of an impending handover to lower (reduce) DRX cycle from the current configured one. This message may be sent along with any measurement reports to the source eNB 1104. The measurement reports may include the configured measurement parameters e.g. downlink signal quality measurements of the source eNB 1104 and target eNB 1106.

The DRX modification request 1114 may be the same as the DRX modification request described above in relation to block 1006 of FIG. 10. For example, the DRX modification request 1114 may be an RRC message or a MAC CE. In some aspects of the disclosure, the UE 1102 may also transmit DRX assistance information 1116 to the source eNB 1104 to assist it in determining the DRX parameters in different scenarios to enhance UE performance (e.g., reduce DRX latency), reduce handover failure, and/or reduce power consumption of the UE. The DRX assistance information 1116 may be included in an RRC message or a MAC CE. In various aspects of the disclosure, the DRX modification request 1114 and DRX assistance information 1116 may be included in the same message or different messages. In some examples, the UE may transmit only the DRX assistance information 1116, which may be interpreted by the eNB as an implied DRX modification request.

In response to the DRX modification request 1114 and/or DRX assistance information 1116, the source eNB 1104 may transmit a plurality of DRX parameters 1118 to the UE 1102. In some examples, the DRX parameters may be transmitted in an RRC message or a MAC CE. In response, the UE 1102 may utilize the DRX block 622 (see FIG. 6) to configure or reconfigure 1120 its DRX operation based on the received DRX parameters so as to reduce a DRX latency of the UE such that handover failure may be reduced. In one particular example, the DRX parameters 1118 may provide the UE 1102 with a larger value for the DRX-inactivity-timer, a smaller value for the shortDRX-Cycle/longDRX-CycleStartOffset, and/or a larger value for the onDuration-Timer.

In some examples, the DRX parameters 1118 may be a DRX command that disables DRX operation of the UE or switches the UE from a current DRX configuration to another predetermined DRX configuration. In some aspects of the disclosure, the source eNB 1104 may choose the DRX parameters 1118 as requested or suggested in the DRX assistance information 1116. However, the source eNB 1104 may also choose a predetermined DRX configuration or DRX parameters 1118 that are different from those requested or suggested in the DRX assistance information 1116 and/or DRX modification request 1114. After the UE 1102 configures its DRX operation, a handover may occur. If the handover occurs, the source eNB 1104 transfers the UE 1102 to the target eNB 1106 by performing a handover procedure 1122. In LTE examples, handover procedures are described in 3GPP Specification 36.300 and 36.331, Release 12, which are incorporated herein by reference. However, the present disclosure is not limited to LTE and handovers in an LTE network. The various aspects of the present disclosure described throughout this specification and drawings may be applied to other networks and handovers within the same network or different networks.

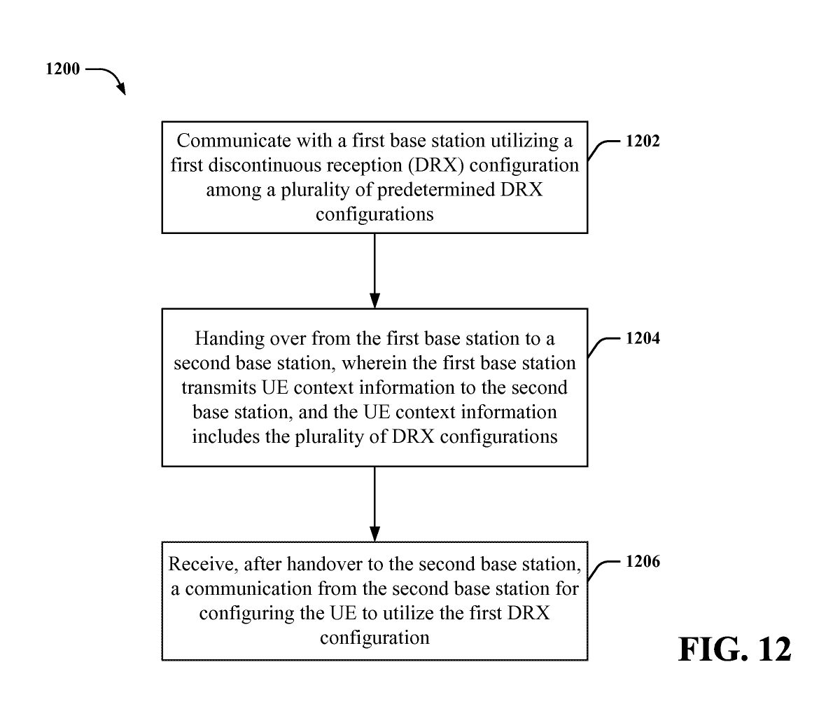

FIG. 12 is a diagram illustrating a handover method 1200 operable at a UE utilizing UE context information in accordance with some aspects of the disclosure. The method 1200 may be performed by an UE illustrated in one or more of FIGS. 1, 2, 6, 7, and 13 or any suitable apparatus. Referring to FIG. 12, at block 1202, the UE may communicate with a first base station utilizing a first DRX configuration (e.g., a first DRX configuration) among a plurality of predetermined DRX configurations. In one example, when implemented as an apparatus 600, the UE may utilize the processor 604 and transceiver 610 (see FIG. 6) to communicate with the first base station utilizing the first DRX configuration.

The UE may anticipate a handover and transmit a request to the first base station to request a modification to a second DRX configuration utilizing a procedure similar to that described FIGS. 10 and 11. If the anticipated handover occurs, at block 1204, the UE may hand over from the first base station to a second base station. The UE may be directed by the first base station (e.g., source eNB) to perform the handover operation. In one example, the UE may utilize the handover block 624 to perform the handover operation. During the handover operation, the first base station transmits UE context information to the second base station. The UE context information may include the plurality of predetermined DRX configurations including the first DRX configuration. The base stations (e.g., eNB) may store the UE context information associated with each active UE. In LTE, for example, the UE context information contains the information for maintaining the E-UTRAN services towards the active UE.

At block 1206, the UE receives, after handover to the second base station, a communication from the second base station for configuring the UE to utilize a third DRX configuration. The third DRX configuration may be the same as the first DRX configuration. That is, the second base station configures the UE to utilize the same DRX configuration after the handover. Therefore, the same power consumption and DRX latency before the handover can be maintained after handover. In some aspects of the disclosure, the third DRX configuration may be different from the first DRX configuration. In one example, the second base station may send the DRX configuration to the UE as an RCC message. In another example, the second base station may send a DRX command as a MAC control element to the UE to utilize a predetermined DRX configuration.

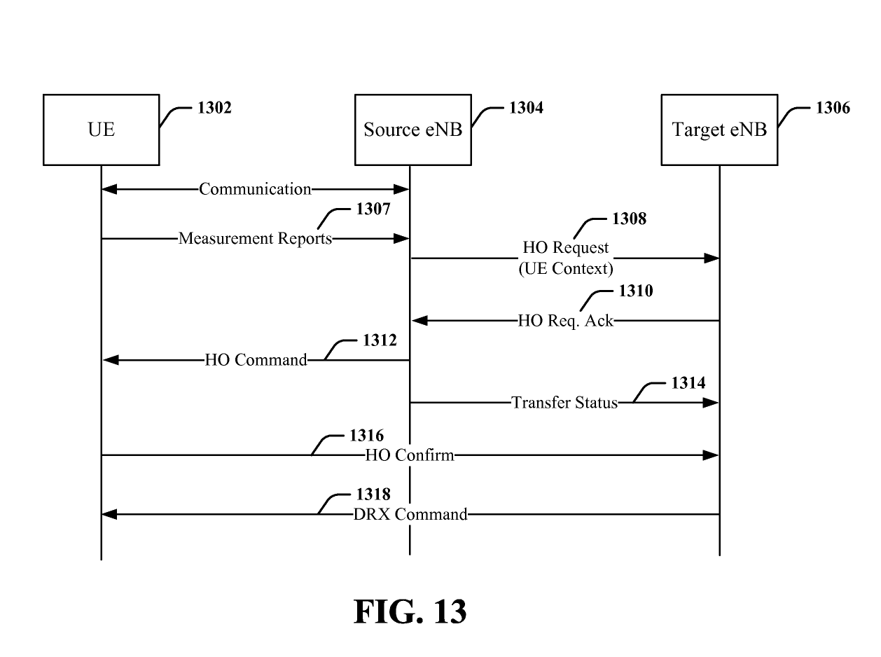

FIG. 13 is a diagram illustrating an example implementation of the handover method 1200 in accordance with an aspect of the disclosure. In FIG. 13, a UE 1302 is initially communicating with a source eNB 1304 in an RRC connected state. The UE 1302 may be a UE illustrated in any one or more of FIGS. 1, 2, 6, 7, and 11 or any suitable apparatus. The source eNB 1304 may be an eNB illustrated in any one or more of FIGS. 1, 2, 6, 7, and 11 or any suitable apparatus. In one particular example, the source eNB 1304 (first base station) may initiate a handover by transmitting a handover (HO) request 1308 to a target eNB 1306 (second base station). The source eNB 1304 may decide to initiate a handover based on UE reported measurements (e.g., measurement reports 1307). The HO request 1308 may include UE context information and other useful information for facilitating the handover. For example, the UE context information may be the same as described in relation to block 1204, and include security parameters, information about the radio bearers, RRC context information, UE's current DRX configuration and/or other predetermined DRX configurations.

In one aspect of the disclosure, the UE context information identifies the UE 1302 and provides the target eNB 1306 with a plurality of predetermined DRX configurations and the DRX configuration being used by the UE. The DRX configuration may be a DRX configuration that was modified due to the anticipation of a handover, or a DRX configuration that was used before such modification. When DRX is enabled at the UE, it may be configured with any one of the predetermined DRX configurations. The DRX configurations allow the UE to be configured for various power consumption and DRX latency settings for different scenarios.

In response to the HO Request 1308, the target eNB 1306 may respond by transmitting a handover request acknowledge 1310 message to the source eNB 1304. The handover request acknowledge message may include information about the accepted radio access bearers (RABs) and DRX configurations. In response, the source eNB 1304 transmits a handover (HO) command message 1312 to the UE 1302. The source eNB 1304 may also transmit a transfer status 1314 message to the target eNB 1306. This message includes information for RABs that are used for continuing ciphering and integrity protection after the handover. In response to the HO command 1312, the UE 1302 transmits a handover confirm 1316 message to the target eNB 1304.

In one aspect of the disclosure, when the UE 1302 has successfully accessed the target eNB 1306, the UE 1302 sends the handover confirm message 1316 to the target eNB 1306 to indicate that the handover procedure is completed for the UE. Then, the target eNB 1306 may transmit a DRX command 1318 (e.g., the communication described in block 1206 FIG. 12) to the UE 1304 such that the UE will be configured with a suitable DRX configuration as that provided by the Source eNB 1304. When implemented as an apparatus 600, the target eNB 1306 may utilize the DRX block 622 and transceiver 610 to transmit the DRX command 1318 to the UE. In some aspects of the disclosure, the DRX command 1318 may configure the UE 1304 to utilize a different DRX configuration among the predetermined DRX configurations included in the UE context information.

In some aspects of the disclosure, the DRX command 1318 received from the target eNB 1306 may be a MAC control element for configuring the UE to utilize the same or different DRX configuration. In aspects of the disclosure, the DRX command 1318 may include a plurality of DRX parameters including at least one of a DRX-inactivity-timer, shortDRX-Cycle, drxShortCycleTimer, longDRX-CycleStartOffset, onDuration-Timer, and drx-RetransmissionTimer.

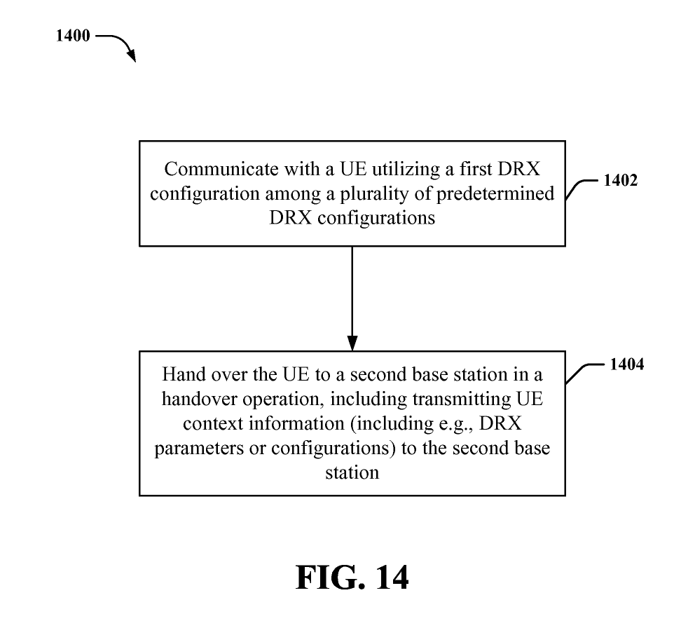

FIG. 14 is a diagram illustrating a handover method 1400 operable at a base station utilizing UE context information in accordance with an aspect of the disclosure. The handover method 1400 may be performed by a base station or eNB illustrated in any one or more of FIGS. 1, 2, 6, 7, 11, and 13 or any suitable apparatus. At block 1402, a first base station communicates with a UE utilizing a first DRX configuration among a plurality of predetermined DRX configurations. In one particular example, the first base station may be the source eNB 1304, and the UE may be the UE 1302 of FIG. 13. At block 1404, the first base station hands over the UE to a second base station in a handover operation. In one example, the second base station may be the target eNB 1306. The first base station may transmit UE context information to the second base station, and the UE context information includes the plurality of DRX configurations or parameters. For example, the UE context information may be the same as those included in the HO Request 1308 of FIG. 13. In one particular example, the UE context information indicates the current (active) DRX configuration of the UE before the handover or a desired DRX configuration after the handover. After handover, the second base station may configure the UE to utilize a DRX configuration based on the UE context information (e.g., DRX configurations) received from the first base station.

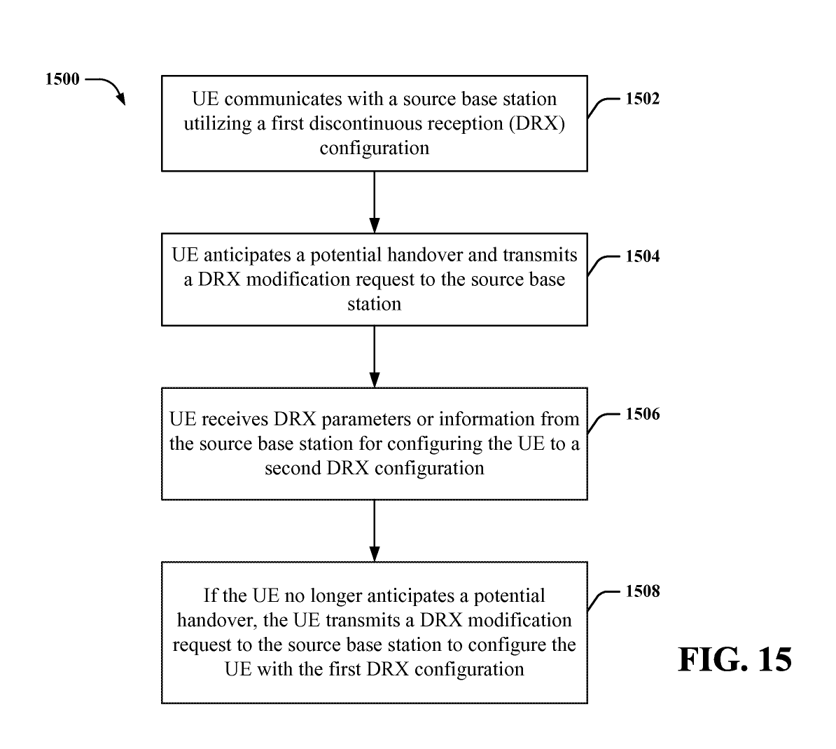

FIG. 15 is a diagram illustrating a handover method 1500 operable at a UE utilizing UE context information in accordance with some aspects of the disclosure. The method 1500 may be performed by an UE illustrated in one or more of FIGS. 1, 2, 6, 7, and 13 or any suitable apparatus. Referring to FIG. 15, at block 1502, the UE may communicate with a first base station utilizing a first DRX configuration (e.g., a first DRX configuration). The first DRX configuration may be one of a plurality of predetermined DRX configurations. In one example, when implemented as an apparatus 600, the UE may utilize the processor 604 and transceiver 610 (see FIG. 6) to communicate with the first base station utilizing the first DRX configuration.

At block 1504, the UE may anticipate a potential handover and transmit a request to the first base station to request a modification to a second DRX configuration (e.g., a second DRX configuration) utilizing a procedure similar to that described in FIGS. 10 and 11. In some aspects of the disclosure, the UE may transmit the DRX modification request when its current DRX cycle is larger than a certain threshold DRX cycle corresponding to a satisfactory handover success/failure rate.

At block 1506, the UE may receive DRX parameters or information from the source base station for configuring the UE to a second DRX configuration. When the UE is configured with the second DRX configuration, it can achieve a tradeoff between power consumption and handover success/failure rate. For example, the second DRX configuration may reduce the DRX related latency such that if a handover actually occurs, the handover success rate may be increased. At block 1508, if the UE no longer anticipates a potential handover (i.e., potential handover condition ceases to exist), the UE may transmit a DRX modification request to the source base station to configure the UE back to the first DRX configuration.

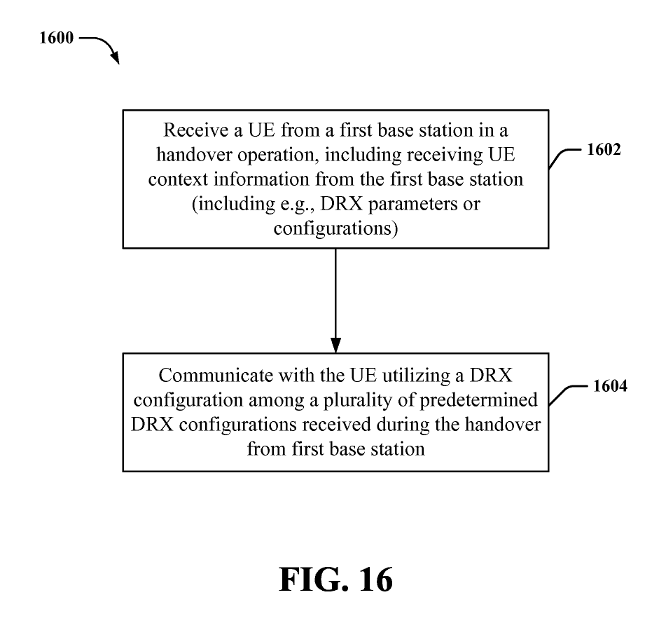

FIG. 16 is a diagram illustrating a handover method 1600 operable at a target base station utilizing UE context information in accordance with an aspect of the disclosure. The handover method 1600 may be performed by a base station or eNB illustrated in any one or more of FIGS. 1, 2, 6, 7, 11, and 13 or any suitable apparatus. Initially, the UE may be communicating with a first base station utilizing a first DRX configuration among a plurality of predetermined DRX configurations. In a handover procedure similar to that described in FIGS. 13 and 14, the first base station (e.g., a source eNB 1304) hands over the UE to a second base station (e.g., a target eNB 1306).

At block 1602, the second base station receives the UE from the first base station in the handover operation, including receiving UE context information from the first base station. The UE context information includes the plurality of predetermined DRX configurations or parameters. For example, the UE context information may be the same as those included in the HO Request 1308 of FIG. 13. After the handover, at block 1604, the second base station may configure the UE to utilize a DRX configuration (e.g., DRX configuration) based on the UE context information received from the first base station.

It is understood that the specific order or hierarchy of steps in the processes disclosed is an illustration of exemplary approaches. Based upon design preferences, it is understood that the specific order or hierarchy of steps in the processes may be rearranged. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method of operating a user equipment (UE) to perform discontinuous reception (DRX) for wireless communication, comprising:
communicating with a first base station utilizing a first discontinuous reception (DRX) configuration;
transmitting a DRX modification request to the first base station, wherein the DRX modification request comprises DRX assistance data for assisting the first base station in determining a second DRX configuration of the UE;
receiving one or more DRX parameters corresponding to the second DRX configuration from the first base station; and
configuring the UE to utilize the second DRX configuration based on the one or more DRX parameters.

2. The method of claim 1, wherein the transmitting a DRX modification request comprises transmitting a power preference indication (PPI) or a media access control (MAC) control element.

3. The method of claim 1, wherein the receiving one or more DRX parameters comprises receiving a radio resource control (RRC) message or a media access control (MAC) control element, comprising the one or more DRX parameters.

4. The method of claim 1, wherein the DRX assistance data comprises information for configuring at least one of a DRX-inactivity-timer, shortDRX-Cycle, drxShortCycleTimer, longDRX-CycleStartOffset, onDuration-Timer, or drx-RetransmissionTimer.

5. The method of claim 1,
wherein the DRX assistance data is configured to indicate the second DRX configuration among a plurality of predetermined DRX configurations, and
wherein the plurality of DRX configurations are configured for different combinations of quality of service (QoS) and mobility scenarios based on respective DRX latency, power consumption of the combinations of QoS and mobility scenarios, and handover success rate.

6. The method of claim 1, wherein the transmitting the DRX modification request comprises:
determining a condition indicative of a potential handover from the first base station to a second base station; and
if the condition indicative of the potential handover exists, transmitting the DRX modification request to the first base station to configure the UE with the second DRX configuration with a reduced DRX latency to increase a handover success rate during handover of the UE to the second base station.

7. The method of claim 6, wherein the transmitting the DRX modification request further comprises:
if the condition indicative of the potential handover ceases to exist, transmitting a DRX modification request to the first base station to configure the UE with the first DRX configuration.

8. The method of claim 6, wherein the DRX modification request is configured to request the first base station to disable a DRX operation of the UE.

9. The method of claim 1, further comprises:
handing over from the first base station to a second base station in a handover operation, wherein the first base station transmits UE context information to the second base station, the UE context information comprising a plurality of predetermined DRX configurations including the first DRX configuration and the second DRX configuration; and
receiving, after the handover to the second base station, a communication from the second base station for configuring the UE to utilize a third DRX configuration of the plurality of predetermined DRX configurations.

10. The method of claim 9, wherein the communication received from the second base station comprises a radio resource control (RRC) message or a media access control (MAC) control element for configuring the UE to utilize the third DRX configuration.

11. The method of claim 9, wherein the communication received from the second base station comprises one or more DRX parameters comprising at least one of a DRX-inactivity-timer, shortDRX-Cycle, drxShortCycleTimer, longDRX-CycleStartOffset, onDuration-Timer, or drx-RetransmissionTimer.

12. A method of operating a base station, comprising:
communicating, at first base station, with a user equipment (UE) utilizing a first discontinuous reception (DRX) configuration among a plurality of predetermined DRX configurations; and
handing over the UE to a second base station in a handover operation comprising transmitting UE context information to the second base station,
wherein the UE context information comprises the plurality of predetermined DRX configurations.

13. The method of claim 12, further comprising receiving a communication from the second base station acknowledging the DRX configurations.

14. The method of claim 12, wherein the UE context information comprises at least one of a DRX-inactivity-timer, shortDRX-Cycle, drxShortCycleTimer, longDRX-CycleStartOffset, onDuration-Timer, or drx-RetransmissionTimer.

15. The method of claim 12, wherein the UE context information is configured to indicate the first DRX configuration being the active DRX configuration utilized by the UE.

16. A user equipment (UE) for wireless communication, comprising:
a memory comprising executable code;
a communication interface; and
at least one processor operatively coupled to the memory and the communication interface, wherein the at least one processor when configured by the executable codes, is configured to:
communicate with a first base station via the communication interface utilizing a first DRX configuration;
transmit a DRX modification request to the first base station, wherein the DRX modification request comprises DRX assistance data for assisting the first base station in determining a second DRX configuration of the UE;
receive one or more DRX parameters corresponding to the second DRX configuration from the first base station; and
configure the UE to utilize the second DRX configuration based on the one or more DRX parameters.

17. The UE of claim 16, wherein for transmitting the DRX modification request, the at least one processor is further configured to transmit a power preference indication (PPI) or a media access control (MAC) control element.

18. The UE of claim 16, wherein for receiving the one or more DRX parameters, the at least one processor is further configured to receive a radio resource control (RRC) message or a media access control (MAC) control element, comprising the one or more DRX parameters.

19. The UE of claim 16, wherein the DRX assistance data comprises information for configuring at least one of a DRX-inactivity-timer, shortDRX-Cycle, drxShortCycleTimer, longDRX-CycleStartOffset, onDuration-Timer, or drx-RetransmissionTimer.

20. The UE of claim 16,
wherein the DRX assistance data is configured to indicate the second DRX configuration among a plurality of predetermined DRX configurations, and
wherein the plurality of DRX configurations are configured for different combinations of quality of service (QoS) and mobility scenarios based on respective DRX latency, power consumption of the combinations of QoS and mobility scenarios, and handover success rate.

21. The UE of claim 16, wherein for transmitting the DRX modification request, the at least one processor is further configured to:
determine a condition indicative of a potential handover from the first base station to a second base station; and
if the condition indicative of the potential handover exists, transmit the DRX modification request to the first base station to configure the UE with the second DRX configuration with a reduced DRX latency to increase a handover success rate during handover of the UE to the second base station.

22. The UE of claim 21, wherein for transmitting the DRX modification request the at least one processor is further configured to:
if the condition indicative of the potential handover ceases to exist, transmit a DRX modification request to the first base station to configure the UE with the first DRX configuration.

23. The UE of claim 21, wherein the DRX modification request is configured to request the first base station to disable a DRX operation of the UE.

24. The UE of claim 16, wherein the at least one processor is further configured to:
hand over from the first base station to a second base station in a handover operation, wherein the first base station transmits UE context information to the second base station, the UE context information comprising a plurality of predetermined DRX configurations including the first DRX configuration and the second DRX configuration; and
receive, after the handover to the second base station, a communication from the second base station for configuring the UE to utilize a third DRX configuration of the plurality of predetermined DRX configurations.

25. The UE of claim 24, wherein the communication received from the second base station comprises a radio resource control (RRC) message or a media access control (MAC) control element for configuring the UE to utilize the third DRX configuration.

26. The UE of claim 24, wherein the communication received from the second base station comprises one or more DRX parameters comprising at least one of a DRX-inactivity-timer, shortDRX-Cycle, drxShortCycleTimer, longDRX-CycleStartOffset, onDuration-Timer, or drx-RetransmissionTimer.

27. A base station for wireless communication, comprising:
a memory comprising executable code;
a communication interface; and
at least one processor operatively coupled to the memory and the communication interface, wherein the at least one processor when configured by the executable code, is configured to:
communicate with a user equipment (UE) utilizing a first discontinuous reception (DRX) configuration among a plurality of predetermined DRX configurations; and
hand over the UE to a second base station in a handover operation comprising transmitting UE context information to the second base station,
wherein the UE context information comprises the plurality of predetermined DRX configurations.

28. The base station of claim 27, wherein the at least one processor is further configured to receive a communication from the second base station acknowledging the DRX configurations.

29. The base station of claim 27, wherein the UE context information comprises at least one of a DRX-inactivity-timer, shortDRX-Cycle, drxShortCycleTimer, longDRX-CycleStartOffset, onDuration-Timer, or drx-RetransmissionTimer.

30. The base station of claim 27, wherein the UE context information is configured to indicate the first DRX configuration being the active DRX configuration utilized by the UE.
